(19) United States
(12) Patent Application Publication
(10) Pub. No.: US 2026/0300011 A1
(43) Pub. Date: Oct. 1, 2026

(54) GENERATIVE MACHINE LEARNING MODEL TRAINING USING DYNAMIC PROMPT ROUTING

(71) Applicant: INTUIT INC., Mountain View, CA (US)

(72) Inventors: Linoy COHEN, Ramat Gan (IL); Matan VETZLER, Ramat Gan (IL); Tom KLEIN, Tel Aviv (IL); Shai ARDAZI, Petah Tikva (IL)

(21) Appl. No.: 19/096,249

(22) Filed: Mar. 31, 2025

(51) Int. Cl. G06F 9/50; G06N 20/00

(52) U.S. Cl. CPC G06F 9/5027; G06N 20/00

(57) ABSTRACT

Aspects of the present disclosure relate to machine learning based automated content generation systems. Certain embodiments relate to a specific training data generation and supervised learning process for training a content generation model. In some embodiments, training data for a content generation machine learning model may be generated by routing training prompts to generative models that are optimized for a particular prompt type. The optimized models, which may each be optimized for a different type of prompt, may be used to generate ground truth outputs for each of the training prompts. The ground truth outputs and the training prompts may then be used as training data for training the content generation machine learning model. Thus, the training of each of the optimized models may be transferred to the content generation machine learning model.

### INTRODUCTION

Aspects of the present disclosure relate to an improved machine learning architecture for automated content generation systems. In particular, techniques described herein involve using a classifier model to route queries to a particular language processing machine learning model based on the type of the query. The particular model may be used to evaluate a response generated by another language processing machine learning model based on the prompt (e.g., to detect hallucinations, inaccurate responses, and/or the like). In some embodiments, the particular model may generate an output based on the query, and the output may be used as a ground truth output for training a computationally efficient model to generate responses to queries.

### BACKGROUND

Every year a growing number of people, businesses, and organizations around the world utilize generative machine learning technologies to automatically generate content. For example, a generative machine learning model may be used to generate answers to questions, responses to commands, summaries of content, images, unique literary works, and/or the like.

To ensure the accuracy and reliability of automatically generated content, an evaluation model may be used. The evaluation model, which may also comprise a machine learning model, may be provided with an input that includes the prompt provided to a generative model and the output generated by the generative model based on the prompt. Based on the input, the evaluation model may generate an output that indicates the accuracy and quality of the output generated by the generative model. For example, the output generated by the evaluation model may indicate whether the generative model hallucinated, whether the generative model completely addressed the prompt, and/or the like.

Tasks performed by machine learning models (e.g., generating content or generating evaluations of content) may require an extensive amount of computational and memory resources. For example, a generative model such as a neural network may process an input through nodes of the neural network to generate an output, such as based on multiplying an input signal by weights that connect the nodes. To reduce the amount of resources required for generating a response, optimization techniques may be used. For example, smaller models or quantized versions of a model may be used. However, using a smaller and/or more heavily quantized model can come with tradeoffs. For example, an output generated by a smaller model may be less accurate and/or less robust than an output generated by a larger model. As a result, users and developers of generative machine learning systems may be forced to choose between efficiency and output quality.

Thus, there is a need in the art for improved techniques of automated content generation using generative machine learning models.

### BRIEF SUMMARY

Certain embodiments provide a method of training a content generation machine learning model. The method generally includes: receiving a training prompt; providing the training prompt as an input to a classification model, wherein the classification model has been trained to route prompts to machine learning models based on a type that corresponds to the prompts; routing the training prompt to a particular generative machine learning model based on an output received from the classification model, wherein the particular generative machine learning model has been optimized for prompts having a particular type; receiving a given output generated by the particular generative machine learning model based on the training prompt; and training the content generation machine learning model through a supervised learning process comprising: providing the training prompt as input to the content generation machine learning model; receiving an output generated by the content generation machine learning model based on the training prompt; and adjusting parameters of the content generation machine learning model based on comparing the output generated by the content generation machine learning model to the given output.

Some embodiments provide a method of automated content generation. The method generally includes: providing a prompt as input to a generative model and a classification model; receiving a given output generated by the generative model based on the prompt; routing the prompt and the given output to a given evaluation machine learning model based on an output generated by the classification model based on the prompt, wherein the output generated by the classification model indicates a type for the prompt, wherein the given evaluation machine learning model has been optimized for prompts having a particular type; receiving, based on the prompt and the given output, a particular output from the given evaluation machine learning model; and performing one or more actions based on the particular output.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to automated content generation.

FIG. 2 depicts an additional example of computing components related to automated content generation.

FIG. 3 depicts an additional example of computing components related to automated content generation.

FIG. 4 depicts an additional example of computing components related to automated content generation.

FIG. 5 depicts example operations related to automated content generation.

FIG. 6 depicts additional example operations related to automated content generation.

FIG. 7 depicts an example of a processing system for automated content generation.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automated content generation.

According to certain embodiments, a prompt (e.g., a natural language prompt submitted by a user) may be provided to a generative machine learning model (e.g., a model that is trained according to one or more processes described herein, or another generative model such as a pre-trained model). The generative machine learning model may then generate an output based on the prompt (e.g., a response to the prompt). According to some embodiments, the output generated by the generative machine learning model may be routed to an evaluation model based on the complexity of the prompt or other features of the prompt. For example, a prompt provided to a generative model may also be provided to a classification model. The classification model may be trained and/or otherwise configured to route prompts and outputs to evaluation models based on the type of the prompt. For example, relatively simple prompts may be routed to a model that is optimized to handle such prompts (e.g., the model may have a number of parameters or a level of quantization that is optimal for evaluating simpler prompts). As another example, relatively complex prompts may be routed to a model that is optimized to handle more complicated prompts. In some embodiments, the prompt may correspond to a particular use case, and classification model may route the prompt to an evaluation model that is trained and/or fine-tuned for this use case.

In some embodiments, a training process for a generative machine learning model involves using training prompts to generate ground truth training data for the generative machine learning model. The training prompts may first be provided to a classification model that is trained to route prompts to machine learning models based on the type of the prompt. For example, relatively simple prompts may be routed to a model that is optimized to handle such prompts (e.g., the model may have a number of parameters or a level of quantization that is optimal for generating a response to simpler prompts). As another example, relatively complex prompts may be routed to a model that is optimized to handle more complicated prompts. In some embodiments, the prompt may correspond to a particular use case, and classification model may route the prompt to a model that is trained and/or fine-tuned for this use case.

The model to which the training prompt is routed may then be used to generate an output based on the training prompt. Because the model is optimized for the particular type of training prompt, the output generated by the model may be used as a ground truth label for the training prompt.

A computationally efficient generative machine learning model may then be trained using a training data set that comprises the training prompt and the ground truth label. For example, the training process may involve providing the training prompt to the generative machine learning model and adjusting parameters of the model until an output generated by the model matches the ground truth label (or until one or more other training conditions are met, as is known in the art if supervised learning).

Embodiments of the present disclosure provide numerous technical and practical effects and benefits. For example, by using a trained classification model to route training prompts to generative models and/or evaluation models based the type of the prompts, techniques disclosed herein allow for accurate and automated performance of tasks such as evaluating model outputs and creating training data. For example, by routing a prompt and an output generated based on the prompt to the smallest, most efficient evaluation model that is suitable for evaluating the output, embodiments disclosed herein minimize the amount of computational resources required to accurately and effectively evaluate generative model outputs. Also, the evaluation process may be completed much faster if prompts and outputs are routed to the smallest model that is suitable for evaluating the output (compared to using a larger evaluation model with more parameters, which may increase latency).

Furthermore, when a generative model is trained using training data that is generated based on routing prompts to models that are optimized for the particular type of prompt, the generative model may be tailored for the use cases and prompts that share characteristics with the training examples. For instance, if a generative model used to generate the training data is optimized for a particular type of prompt, that optimization may be transferred to a model that is trained using the training data according to embodiments disclosed herein. Additionally, a model trained in such a manner may require far fewer computational resources to operate than models that would otherwise be necessary for generating accurate and robust responses to a wide variety of prompts, such as large language models. As a result, the training techniques disclosed herein allow for building a model that can achieve equal or better performance when compared to larger, more computationally costly models.

Also, once trained using training data that is generated according to certain embodiments, the generative machine learning model may generate outputs that match the accuracy/robustness of a system that uses both a classification model to route a prompt to an optimized model for the prompt as well as the optimized model. In other words, embodiments disclosed herein allow for training a generative model to achieve an output quality that would otherwise require the execution of at least two models to achieve. As a result, latency may be significantly reduced and computational resource requirements may also be significantly reduced. Additionally, a model that is trained according to teachings disclosed herein may have a smaller number of parameters than the classification model and/or the model used to generate the training data, resulting in further latency reductions and resource efficiency improvements.

Furthermore, embodiments of the present disclosure may reduce the amount of computational resources required for generating training data compared to other automated techniques. For example, each training prompt may be routed to the smallest model required to generate a reliable ground truth output. Thus, a smaller model may be used to generate the ground truth as opposed to a more computationally expensive model with a larger number of parameters.

### Example of Computing Components Related to Automated Content Generation

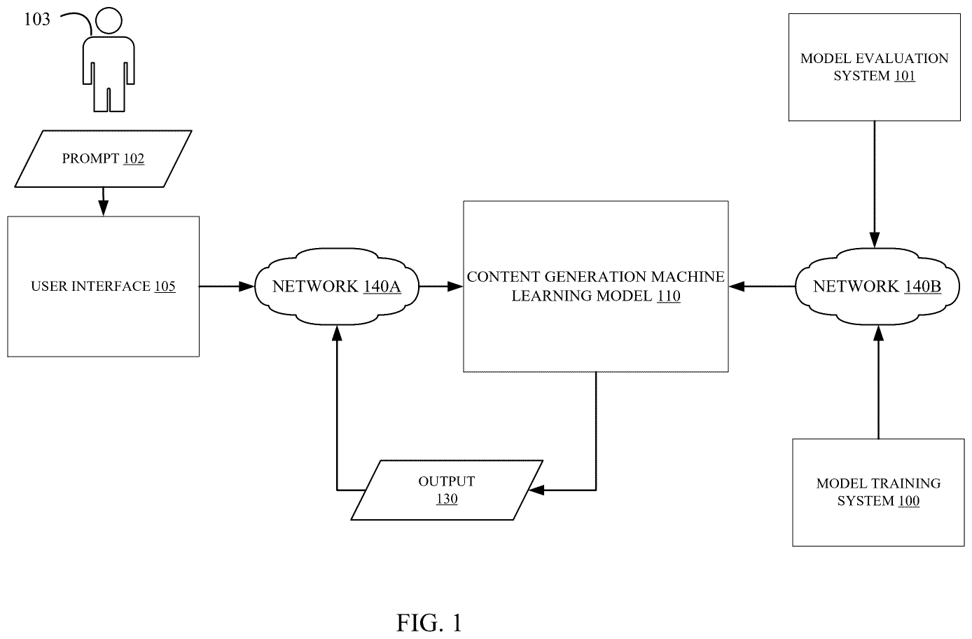

FIG. 1 depicts an example of computing components related to automated content generation.

A user 103 may interact with a generative machine learning model system via a user interface 105 associated with a computing device. The generative machine learning model system may, for example, comprise a software application that may be used to deliver content to the user 103. The generative machine learning model system may be used to generate content based on prompts 102 submitted by the user 103 via the user interface 105. For example, the generative machine learning model system may be used to generate an output 130 (e.g., a response to prompt 102) comprising text such as answers to questions, summaries of other forms of content, responses to commands, other forms of responses based on other content, and/or the like. Responses may be in forms other than text. For example, a response may comprise one or more images, videos, audio data, and/or the like. The output 130 may be provided to the user 103 via the user interface 105.

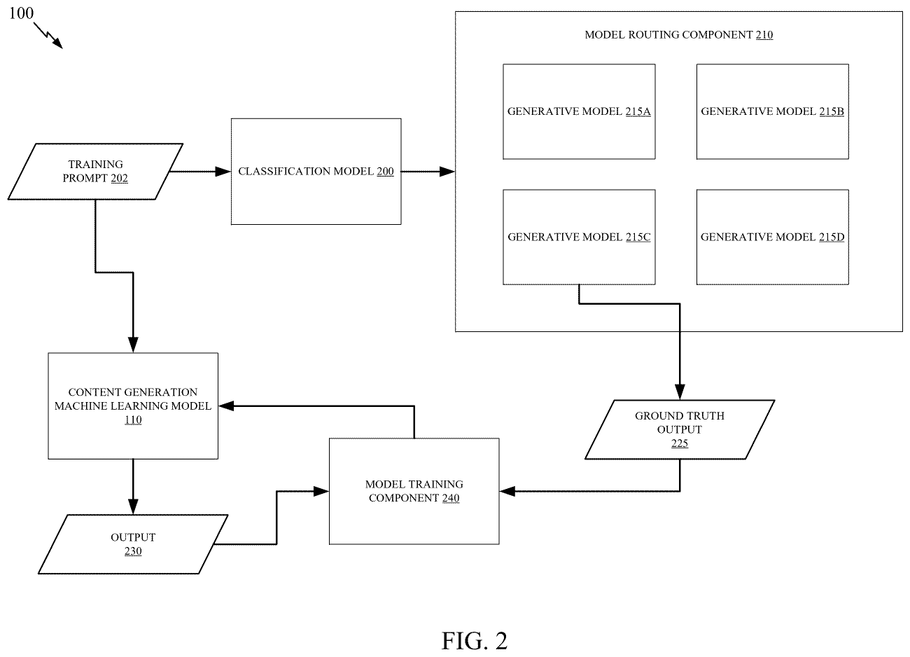

The generative machine learning model system may comprise a content generation machine learning model 110 that generates responses to prompts. For example, the content generation machine learning model 110 may be any suitable type of generative machine learning model, such as a generative adversarial network, a variational autoencoder, an autoregressive model, a transformer model, a language processing machine learning model, a recurrent neural network, or the like. As discussed in further detail below with respect to FIG. 2, the content generation machine learning model 110 may be trained using a model training system 100. The training process may involve generating ground truth responses to training prompts by routing each training prompt to one or more generative models optimized for certain types of prompts. For example, a classification model may be used to assign a type to a training prompt. Then, the prompt may be routed to the model that is optimized (e.g., trained, fine-tuned, having a level of quantization/number of parameters, and/or the like) for the assigned type. Once each training prompt is routed to a model that is optimized for the prompt, the outputs generated by the optimized models may be used as training data to train the content generation machine learning model 110. As a result, the training for each of the optimized models may be transferred to the content generation machine learning model 110. Accordingly, the trained content generation machine learning model 110 may be optimized for a wide range of prompts that correspond to the various training examples. The resulting content generation machine learning model 110 may have a smaller size (e.g., number of parameters) than many of the optimized models used to generate the training data (the size may also be much smaller than general purpose generative models, such as large language models). Thus, the content generation machine learning model 110 may generate outputs that are as accurate/robust as the outputs of the larger optimized models while using far fewer computational resources.

The generative machine learning model system may comprise a model evaluation system 101 that is configured to evaluate the outputs generated by a generative model (e.g., output 130 generated by content generation machine learning model 110). For example, the model evaluation system 101 may be used to determine whether the output 130 is a complete, accurate, and relevant response to the prompt 102. As another example, the model evaluation system 101 may be used to detect hallucinations in the output 130. The model evaluation system 101 may comprise multiple evaluation models, and the prompt and the output generated based on the prompt may be routed to the evaluation model that is optimized for the prompt. For example, a first evaluation model may be optimized for simple prompts (e.g., the first evaluation model may have a relatively low number of parameters). As a result, if the prompt is simple, it may be routed to the first evaluation model. As another example, a second evaluation model may be optimized (e.g., trained or fine-tuned) for a particular use case, and prompts that correspond to that use case may be routed to the second evaluation model. One or more actions may be taken based on the evaluation generated by an evaluation model. For example, if deficiencies in an output are detected (e.g., hallucinations and/or inaccuracies), the generation process may be repeated, a model may be retrained, and/or the like. As another example, if no deficiencies are detected, the output may be provided to the user 103 via the user interface 105.

The computing device(s) associated with the user interface 105, the content generation machine learning model 110, the model evaluation system 101, and the model training system 100 may interact over one or more networks 140A-B. Networks 140 may be any connection over which data may be transmitted. In one example, networks 140 are the Internet.

FIG. 2 depicts an additional example of computing components related to automated content generation. In particular, FIG. 2 depicts functionality that may be performed by the model training system 100 of FIG. 1.

A training prompt 202 may be provided as input to a classification model 200. The training prompt 202 may comprise a natural language prompt or the like.

The classification model 200 may generally be any type of model that is capable of generating an output indicating a model to which a training prompt should be routed. In some embodiments, the classification model 200 may comprise a machine learning model, such as a neural network. In an example embodiment, the classification model 200 comprises a decoding-enhanced Bidirectional Encoder Representation from Transformer with disentangled attention (DeBERTa) model. In certain embodiments, the classification model 200 may comprise a tree-based machine learning model such as a gradient boosted tree, random forest, and/or the like. In some embodiments, the classification model 200 may comprise a Bayesian classifier, a regression model, a support vector machine, and/or the like.

Some embodiments provide that the classification model 200 is trained to generate an output that indicates a generative model 215 to which the training prompt 202 will be routed. For example, various training prompts corresponding to various different use cases may be provided to the classification model 200, and the classification model 200 may route the prompts to generative models 215 to generate ground truth outputs for training data.

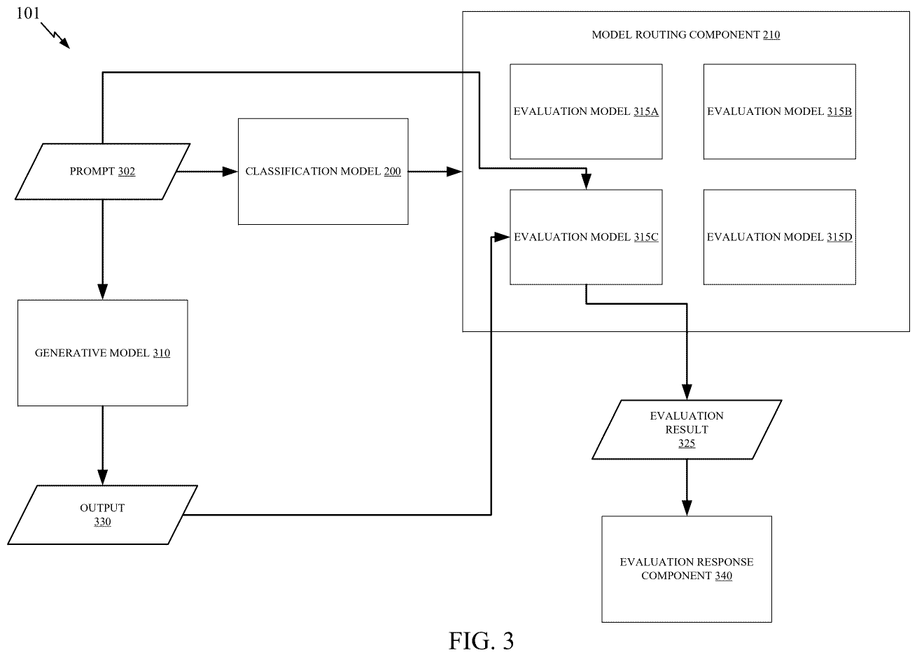

The classification model 200 (and/or generative models 215, content generation machine learning model 110, or any other model used in techniques described herein) may be trained based on supervised, unsupervised or semi-supervised learning techniques. For example, the classification model 200 may be trained through a supervised learning process involving training data generated as described below with respect to FIG. 3.

Supervised learning techniques generally involve providing training inputs to a machine learning model. The machine learning model processes the training inputs and outputs predictions based on the training inputs. The predictions are compared to known labels associated with the training inputs to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the predictions produced by the machine learning model based on the training inputs match the known labels associated with the training inputs or whether a measure of error between training iterations is not decreasing or not decreasing more than a threshold amount. The conditions may also include whether a training iteration limit has been reached. Model parameters adjusted during training may include, for example, hyperparameters, values related to numbers of iterations, weights, functions used by nodes to calculate scores, level of randomness, and/or the like. In some embodiments, validation and testing are also performed for a machine learning model (e.g., classification model 200, generative models 215, content generation machine learning model 110, and/or any other model used in techniques described herein), such as based on validation data and test data, as is known in the art.

In some embodiments, back-propagation is used to train one or more of the machine learning models disclosed herein. Back-propagation refers to a process of calculating a gradient based on a loss function, comparing recreated input with the actual input or comparing a generated output with a ground truth output. By propagating this gradient “back” through the layers of the machine learning model, the weights can be modified to produce more accurate outputs on subsequent attempts.

A supervised learning process for the classification model 200 may comprise providing a training prompt to the classification model 200. The training prompt may, for example, comprise a prompt that was historically provided to one or more generative machine learning models. The training prompt may further be associated with a label indicating a particular generative model (e.g., the smallest model that generated an appropriate response for that training prompt during a training data generation process, a model that generated the most accurate/robust response to the training prompt, a model that achieved a desired balance between accuracy and efficiency, and/or the like). The classification model 200 may generate an output that indicates a generative model. The output may be compared to the label, and one or more parameters of the classification model 200 may be adjusted based on a variance between the label and the output.

Certain embodiments provide that the classification model 200 comprises an embedding model. An embedding generally refers to a vector representation of an entity that represents the entity as a vector in n-dimensional space such that similar entities are represented by vectors that are close to one another in the n-dimensional space. The embedding model may comprise a neural network or other type of machine learning model that learns a representation (embedding) for an entity through a training process that trains the neural network based on a data set, such as a plurality of features of a plurality of entities. In one example, the embedding model comprises a Bidirectional Encoder Representations from Transformer (BERT) model, which involves the use of masked language modeling to determine embeddings. In a particular example, the embedding model comprises a Sentence-BERT model. In other embodiments, the embedding model may involve embedding techniques such as Word2Vec and GloVe embeddings. These are included as examples, and other techniques for generating vector representations of entities (such as embedding representations) are possible.

In some embodiments, the classification model 200 may generate embeddings of training prompts 202, and the embeddings may be compared (e.g., based on clustering techniques and/or semantic similarity algorithms) to labeled embeddings of prompts (e.g., based on labels applied to prompts as discussed below with respect to FIG. 3) to determine which prompts are most similar to the user-provided prompt. If the training prompt 202 is most similar to a group of prompts associated with a particular generative model (e.g., an embedding cluster) or a particular prompt associated with the particular generative model, an output may be generated that indicates the particular generative model. Embedding representations of prompts may be clustered using a clustering algorithm (e.g., a k-Means algorithm).

The output of the classification model 200, which indicates a particular generative model, may be provided to the model routing component 210. The model routing component 210 may comprise a computing component that is configured to route the training prompt 202 to a generative model 215 based on the output of the classification model 200. For example, the generative model system may comprise four generative machine learning models 215A-D that are each optimized (e.g., trained and/or fine-tuned) to a different task/type of prompt. Although four generative models 215 are shown in this example, it is contemplated that more or fewer generative models 215 may be used.

The generative models 215 may be generally any type of machine learning model that is capable of generating an output based on a prompt. For example, the generative models 215 may be transformer-based models such as large language models (LLMs). In other embodiments, the generative models 215 may comprise long short-term memory (LSTM) models, convolutional neural networks, recurrent neural networks, vision models, and/or the like. In some embodiments, generative models 215 may include multiple “versions” of the same machine learning model with different levels of quantization and/or numbers of parameters. As an example, generative model 215A may be a model with a relatively small number of parameters that is highly fine-tuned for a specific type of prompt or a specific use case. A separate generative model may be a version of generative model 215A to which quantization has been applied. The quantized version may be used for prompts that are simpler than the prompts routed to generative model 215A. Generative model 215B may be a model with a relatively small number of parameters that is highly fine-tuned for a different type of prompt or a different use case. Generative model 215C may be relatively larger model that is trained for the specific prompt or use case (although trained for the same type of prompt/use case, the training of generative model 215C may be more general than the training of generative model 215A in some embodiments). Generative model 215D may be a larger, more generally trained model than the other models (e.g., a general-purpose pre-trained LLM). These model descriptions are intended as examples, and different models may be used.

Quantization generally refers to a process used to reduce the bits in the weights (and, in some aspects, in activation values) of a machine learning model. As an example, if the weights of a machine learning model are sixty-four bits, quantization may be used to reduce each weight to thirty-two bits. The smaller weights may require significantly less memory to store and require significantly less computational power to process.

In an example, the training prompt 202 may be provided to the classification model 200. The classification model 200 may generate an output indicating that generative model 215D should be used for generating a response to the training prompt 202. Based on this, the training prompt 202 may be routed to generative model 215D, a general purpose LLM. As another example, the output from the classification model 200 may indicate generative model 215A (e.g., a smaller model that is more highly fine-tuned to a particular use case/type of prompt). Based on this, the training prompt 202 may be routed to generative model 215A. As shown in the example embodiment depicted in FIG. 2, the training prompt is routed to generative model 215C.

Once the training prompt 202 is routed to a generative model 215, the generative model 215 may generate ground truth output 225 based on the training prompt 202. For example, the training prompt 202 may comprise a question, a request for content, and/or the like. The ground truth output 225 may comprise an answer to the question, the requested content, and/or the like. The ground truth output 225 may be considered a ground truth response to the training prompt 202 because the training prompt 202 was routed to a generative model that was optimized for generating responses to prompts that are similar to the training prompt 202. The ground truth output 225 may be used to train content generation machine learning model 110. In some embodiments, the generative models 215A-D are evaluation models that are used to evaluate the output of other models (e.g., the generative models 215A-D may generate an output comprising an evaluation of a given output based on being provided with the prompt and the given output) Thus, the ground truth output 225 may comprise a ground truth evaluation for a prompt and the output generated based on the prompt. When trained using a training data set that comprises the prompt, the output generated based on the prompt, and the ground truth output 225, the content generation machine learning model 110 may be trained to be an evaluator model.

As part of the training process for the content generation machine learning model 110, the training prompt 202 may be provided as part of an input to the content generation machine learning model 110. Based on the input, the content generation machine learning model 110 may generate an output 230 (e.g., a response to the training prompt 202). The output 230 and the ground truth output 225 may be provided to a model training component 240. The model training component 240 may then compare the output 230 to the ground truth output 225 and adjust parameters of the content generation machine learning model 110 (e.g., through a backpropagation process) based on a variance between the output 230 and the ground truth output 225. For example, the parameters may be adjusted until the similarity is above a threshold or another condition is met.

In some embodiments, the model training component 240 may use text-based and/or semantic similarity-based techniques for comparing the output 230 and the ground truth output 225. In some embodiments, the model training component 240 may use a text-based comparison technique such as n-grams (n-grams are generally groups of up to n consecutive words or characters, where n is a positive integer). For instance, n-grams of output 230 may be compared to n-grams of ground truth output 225 using a bilingual evaluation understudy (BLEU) algorithm, a recall-oriented understudy for gisting evaluation (ROUGE) algorithm, an edit distance algorithm, and/or the like.

Certain embodiments provide that the comparison may comprise a semantic similarity comparison. For example, embedding representations may be created of output 230 and the ground truth output 225. The embedding representations may be compared using a semantic similarity algorithm (e.g., cosine similarity). In other embodiments, the model training component 240 may comprise a machine learning model configured to compare two outputs and generate an indication of the similarity between the outputs (e.g., based on LLM-as-judge techniques). These comparison techniques are included as examples only, and other techniques for comparing the similarity of two outputs may be used.

Once trained based on the generated ground truth outputs, the training of the generative models 215A-C may be transferred to the content generation machine learning model 110. Accordingly, for input prompts that are provided to the content generation machine learning model 110, outputs may be generated that match or exceed the quality and robustness of an output generated by any of the generative models 215A-D when provided with the same prompt. Furthermore, the trained content generation machine learning model 110 may be more computationally efficient than one or more of the generative models 215A-D. For example, the content generation machine learning model 110 may require fewer parameters than other generative models because the content generation machine learning model 110 is trained using a more targeted dataset (e.g., a dataset comprising the training prompts and corresponding ground truth outputs for each training prompt) than the other generative models.

FIG. 3 depicts an additional example of computing components related to automated content generation. In particular, FIG. 3 depicts functionality that may be performed by the model evaluation system 101 of FIG. 1.

A prompt 302 may be provided as input to the classification model 200. The prompt 302 may comprise a natural language prompt or the like.

As discussed above with respect to FIG. 2, the classification model 200 may be trained and/or otherwise configured to generate an output that indicates a model to which a prompt 302 should be routed. For example, relatively simple prompts may be routed to a first model (e.g., a model that has a relatively small number of parameters or a relatively high level of quantization), relatively complex prompts may be routed to a second model (e.g., a model that has a relatively large number of parameters or a relatively low level of quantization), prompts that correspond to a particular use case may be routed to a third model that is optimized (e.g., trained or fine-tuned) for that use case, and prompts that correspond to a different use case may be routed to a fourth model that is optimized for that use case. Thus, in some embodiments, prompts 302 may be routed to the smallest, most efficient model that is suitable for handling the prompt.

As shown in FIG. 3, each of the models 315A-D are evaluation models that are configured to evaluate the output generated by a generative model (e.g., a machine learning model such as an LLM). The evaluation models 315A-D may be configured to accept an input comprising an output 330 generated by the generative model 310 based on a prompt 302 as well as the prompt 302. Based on the prompt 302 and the output 330, an evaluation model 315 may generate an evaluation result 325, an output comprising an indication of any deficiencies in the output 330. For example, if the output 330 is off-topic for the prompt or does not fully address the prompt, the evaluation result 325 may indicate these deficiencies. As another example, if the output is inaccurate or contains hallucinations, the evaluation result 325 may indicate these deficiencies. By contrast, for accurate outputs 330 that fully and sufficiently address the prompt 302, the evaluation result 325 may indicate that no deficiencies are present. As shown in this example, the model routing component 210 routes the prompt 302 and the output 330 to evaluation model 315C, which generates the evaluation result 325.

The evaluation models 315 may be generally any type of machine learning model that is capable of generating an output based on a prompt. For example, the evaluation models 315 may be transformer-based models such as large language models (LLMs). In other embodiments, the evaluation models 315 may comprise long short-term memory (LSTM) models, convolutional neural networks, recurrent neural networks, vision models, and/or the like. In some embodiments, evaluation models 315 may include multiple “versions” of the same machine learning model with different levels of quantization and/or numbers of parameters. As an example, evaluation model 315A may be a model with a relatively small number of parameters that is highly fine-tuned for a specific type of prompt or a specific use case. A separate generative model may be a version of evaluation model 315A to which quantization has been applied. The quantized version may be used for prompts that are simpler than the prompts routed to evaluation model 315A. Evaluation model 315B may be a model with a relatively small number of parameters that is highly fine-tuned for a different type of prompt or a different use case. Evaluation model 315C may be relatively larger model that is trained for the specific prompt or use case (although trained for the same type of prompt/use case, the training of evaluation model 315C may be more general than the training of evaluation model 315A in some embodiments). Evaluation model 315D may be a larger, more generally trained model than the other models (e.g., a general-purpose pre-trained LLM). These model descriptions are intended as examples, and different models may be used.

The evaluation result 325 may be provided to evaluation response component 340, which may comprise one or more computing components that are configured to perform tasks based on the evaluation result 325. For example, if the evaluation result 325 indicates deficiencies in the output 330, the retraining processes may be initiated for the generative model 310 and/or the classification model 200. As another example, if the evaluation result 325 indicates deficiencies in the output 330, one or more steps of the content generation process may be repeated (e.g., the generative model 310 may be prompted to generate the output 330 again). If the evaluation result 325 indicates that there are no deficiencies in the output 330, the output 330 may be provided to a user via a user interface or used for other tasks.

In some embodiments, one or more of the evaluation models 315A-D, the classification model 200, and/or the generative model 310 may be retrained based on user feedback provided with respect to the output 330. For example, the user feedback may indicate that the output contains deficiencies and/or describe the deficiencies. Based on the feedback, labeled training data may be created and used to retrain or fine tune one or more of the models. For example, an evaluation model 315 that was used to evaluate the output may be retrained such that the evaluation model will identify the deficiencies indicated in the feedback (e.g., by adjusting parameters of the evaluation model 315 based on the feedback until an evaluation result 325 generated by the evaluation model 315 indicates the deficiencies). As another example, the classification model 200 may be retrained such that the prompt is routed to a different evaluation model 315.

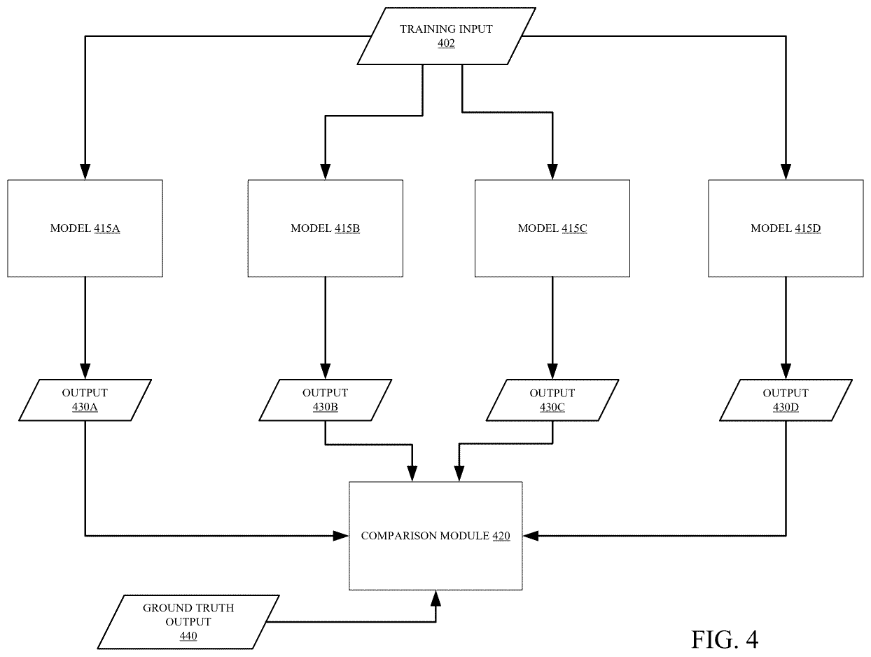

FIG. 4 depicts an additional example of computing components related to automated content generation. In particular, FIG. 4 depicts functionality that may be used to train classification model 200. Although four models 415 are shown in this illustrative example, more or fewer models may be used. Models 415 may be generative models as described with respect to FIG. 2 or evaluation models as described with respect to FIG. 3.

A training input 402 may be provided as input to model 415A. As discussed above with respect to FIG. 2 or FIG. 3, model 415A may be a model that is optimized for a particular type of prompt. For example, if model 415A is optimized for relatively simple prompts, model 415A may have a smaller number of parameters and/or a larger level of quantization. As another example, model 415A may be optimized for a particular task or use case. Another model, such as model 415D may be a larger model such as a general purpose LLM, a model that is fine-tuned for a different task, a larger model optimized for the same task, and/or the like. Other configurations for the models are possible.

The training input 402 may comprise a training prompt. In embodiments where models 415A-D are evaluation models, the training input may further comprise an output that is to be evaluated by on the training prompt. When provided with the training input 402, model 415A may generate an output 430A. The training input 402 may also be provided to each of the other models 415B-D, which may generate respective outputs 430B-D based on the training input 402. Outputs 430A-D may then be provided to comparison module 400. Comparison module 420 may comprise a computing component that is configured to generate an indication of the similarity of each of the outputs 430A-D to a ground truth output 440. In some embodiments, comparison module 420 may use a text-based comparison technique such as n-grams. For instance, n-grams of output 430A may be compared to n-grams of ground truth output 440 using a bilingual evaluation understudy (BLEU) algorithm, a recall-oriented understudy for gisting evaluation (ROUGE) algorithm, an edit distance algorithm, and/or the like. Certain embodiments provide that the comparison may comprise a semantic similarity comparison. For example, embedding representations may be created of output 430A and ground truth output 440. The embedding representations may be compared using a semantic similarity algorithm (e.g., cosine similarity). In other embodiments, the comparison module 420 may comprise a machine learning model configured to compare two outputs and generate an indication of the similarity between the outputs (e.g., based on LLM-as-judge techniques). These comparison techniques are included as examples only, and other techniques for comparing the similarity of two outputs may be used.

Based on the indication of similarity generated by the comparison module 420, the training input 402 may be labeled. For example, if the similarity of output 430B and ground truth output 440 exceeds a threshold, training input 402 may be labeled to indicate that model 415B is the most suitable model for the training input 402.

In some embodiments, training inputs that correspond to a particular use case may be provided to models that correspond to the use case. The training inputs may be provided to the models in ascending order based on the size of the models. For example, a training input may be provided to the model with the smallest number of parameters and/or the highest level of quantization first. After a model generates an output that matches the ground truth by a threshold amount (e.g., based on semantic similarity), the training input may be labeled and not provided to the other models. By comparing the output from the smallest model to the ground truth first, techniques described herein avoid the need to generate an output using one or more larger models at all if the output from the smallest model is sufficiently similar to the ground truth. Thus, aspects of the present disclosure may involve working serially from the smallest model to the largest model when generating outputs and comparing those outputs to the output from the non-quantized model, thereby improving efficiency and avoiding unnecessary computing resource utilization when generating training data.

Alternate embodiments provide that the training input 402 may be labeled manually. For example, the comparison may be made manually based on outputs of the various models 415.

As described above with respect to FIG. 2, the labeled training input 402 may be used as training data to train the classification model 200.

In some embodiments, user feedback may be received with respect to a generated output that is provided to a user. For example, the user feedback may comprise a natural language indication of the level of quality/relevance of the output (e.g., which may be processed according to natural language processing techniques as known in the art), a selection of a multiple choice answer regarding quality/relevance of an output, a user interaction or non-interaction with the output, and/or the like. Based on the user feedback, the classification model 200, one or more evaluation models, one or more generative models, and/or the content generation machine learning model 110 may be retrained. For example, based on user feedback indicating issues with a generated output, the prompt provided by the user may be given a label indicating a generative model that is optimized for the user-provided prompt, and the user-provided prompt may be used as labeled training data to train the classification model 200. In another example, parameters of the content generation machine learning model 110 may be adjusted until an output generated by the content generation machine learning model 110 matches a ground truth output for the user-provided prompt (or another condition is met). Accordingly, the content generation machine learning model 110 and the classification model 200 used to generate training data for the content generation machine learning model 110 may each be continuously improved based on user interactions with the content generation system.

### Example Operations Related to Automated Content Generation

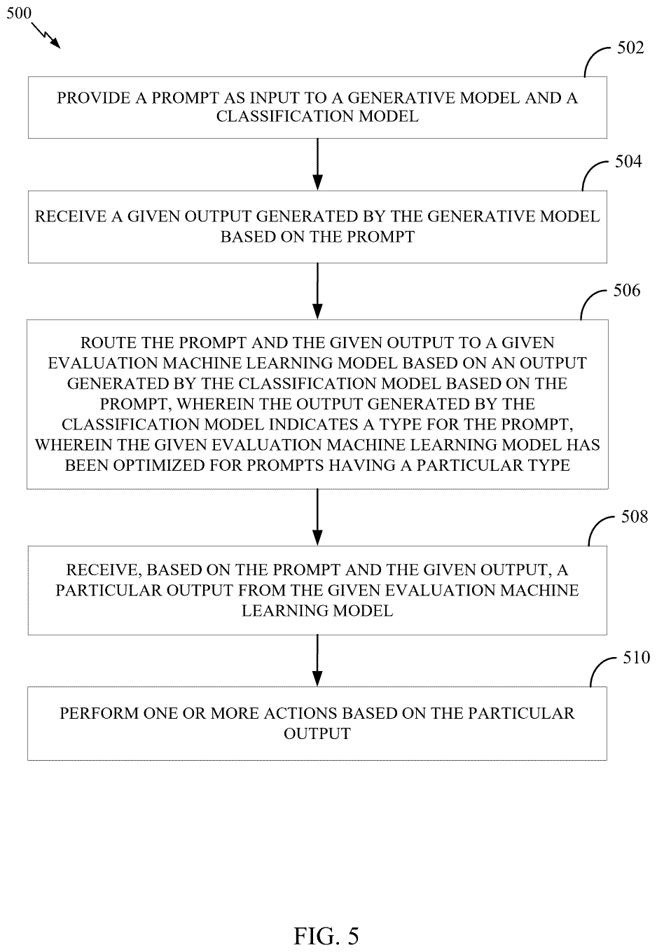

FIG. 5 depicts example operations 500 related to automated content generation. For example, operations 500 may be performed by one or more of the components described with respect to FIG. 1, FIG. 3, and FIG. 4.

Operations 500 begin at step 502 with providing a prompt as input to a generative model and a classification model.

Operations 500 continue at step 504 with receiving a given output generated by the generative model based on the prompt.

Operations 500 continue at step 506 with routing the prompt and the given output to a given evaluation machine learning model based on an output generated by the classification model based on the prompt, wherein the output generated by the classification model indicates a type for the prompt, wherein the given evaluation machine learning model has been optimized for prompts having a particular type. Some embodiments provide that optimization for the given evaluation machine learning model is based on a number of parameters of the given evaluation machine learning model. In certain embodiments, routing the prompt and the given output to the given evaluation machine learning model comprises, based on the output generated by the classification model indicating that the prompt has a relatively low level of complexity, routing the prompt and the given output to the given evaluation machine learning model, wherein the given evaluation machine learning model has a number of parameters or a level of quantization that corresponds to the relatively low level of complexity. Some embodiments provide that routing the prompt and the given output to the given evaluation machine learning model comprises, based on the output received from the classification model indicating that the prompt has a relatively high level of complexity, routing the prompt and the given output to the given evaluation machine learning model, wherein the given evaluation machine learning model has a number of parameters or a level of quantization that corresponds to the relatively high level of complexity.

Operations 500 continue at step 508 with receiving, based on the prompt and the given output, a particular output from the given evaluation machine learning model.

Operations 500 continue at step 510 with performing one or more actions based on the particular output. Certain embodiments provide that the one or more actions comprise retraining the generative model based on the particular output indicating a deficiency in the given output. Some embodiments provide that the one or more actions comprise repeating one or more content generation steps based on the particular output indicating a deficiency in the given output. According to certain embodiments, the one or more actions comprise providing the given output to a user via a user interface based on the particular output indicating a lack of deficiencies in the given output.

In certain embodiments, the method further comprises receiving user feedback based on the given output; and retraining the generative model, the given evaluation machine learning model, or the classification model based on the user feedback.

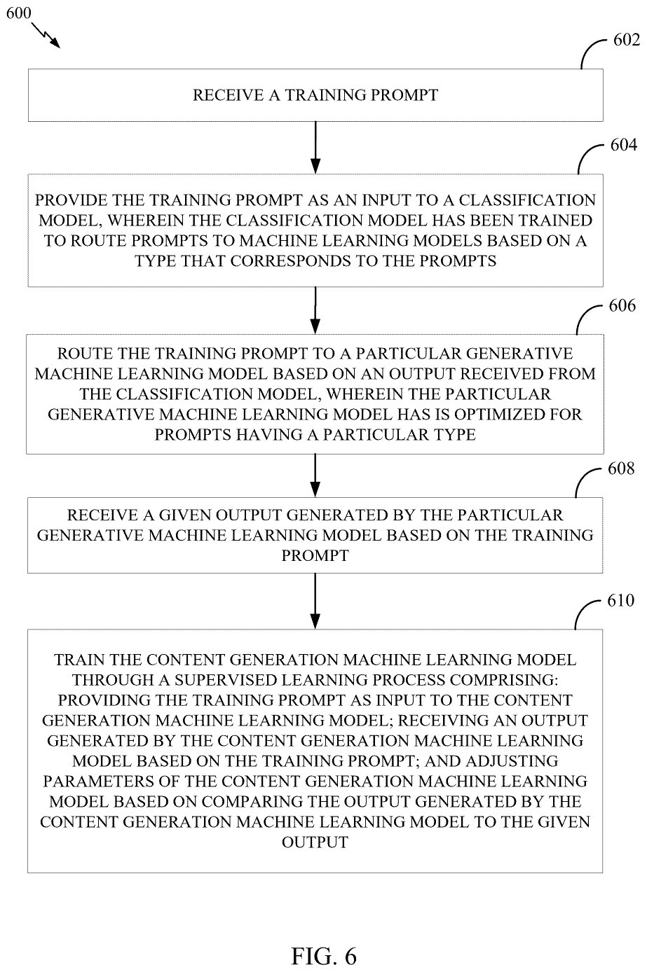

FIG. 6 depicts example operations 600 related to automated content generation. For example, operations 600 may be performed by one or more of the components described with respect to FIG. 1, FIG. 2, and FIG. 4.

Operations 600 begin at step 602 with receiving a training prompt.

Operations 600 continue at step 604 with providing the training prompt as an input to a classification model, wherein the classification model has been trained to route prompts to machine learning models based on a type that corresponds to the prompts.

Operations 600 continue at step 606 with routing the training prompt to a particular generative machine learning model based on an output received from the classification model, wherein the particular generative machine learning model has been optimized for prompts having a particular type. In certain embodiments, optimization for the particular machine learning model is based on a number of parameters of the particular machine learning model. In some embodiments, routing the training prompt to a particular generative machine learning model comprises, based on the output received from the classification model indicating that the training prompt has a relatively low level of complexity, routing the prompt to the particular generative machine learning model, wherein the particular generative machine learning model has a number of parameters that corresponds to the relatively low level of complexity. Certain embodiments provide that routing the training prompt to a particular generative machine learning model comprises, based on the output received from the classification model indicating that the training prompt has a relatively high level of complexity, routing the prompt to the particular generative machine learning model, wherein the particular generative machine learning model has a number of parameters or a level of quantization that corresponds to the relatively high level of complexity.

Operations 600 continue at step 608 with receiving a given output generated by the particular generative machine learning model based on the training prompt.

Operations 600 continue at step 610 with training the content generation machine learning model through a supervised learning process comprising: providing the training prompt as input to the content generation machine learning model; receiving an output generated by the content generation machine learning model based on the training prompt; and adjusting parameters of the content generation machine learning model based on comparing the output generated by the content generation machine learning model to the given output. Certain embodiments provide that embedding representations of the output generated by the content generation machine learning model and the given output are created; and the adjusting continues until the embedding representation of the output generated by the content generation machine learning model and the embedding representation of the given output have a level of semantic similarity above a threshold.

Certain embodiments provide that the trained content generation machine learning model is used to generate content based on an input prompt.

According to certain embodiments, user feedback is received based on the generated content; and the content generation machine learning model is retrained based on the user feedback. Some embodiments provide that the classification model is retrained based on the user feedback.

In certain embodiments, the method further comprises routing a plurality of training prompts, each training prompt of the plurality of training prompts corresponding to a different use case, to generative machine learning models based on a type corresponding to each training prompt of the plurality of training prompts and receiving a set of outputs from the generative machine learning models based on the prompts, each respective output of the set of outputs corresponding to a respective training prompt of the plurality of training prompts, wherein training the content generation machine learning model further comprises, for each given training prompt of the plurality of training prompts, adjusting parameters of the content generation machine learning model based on comparing an output generated by the content generation machine learning model for the given training prompt to a given output of the set of outputs that corresponds to the given training prompt.

### Example of a Processing System for Automated Content Generation

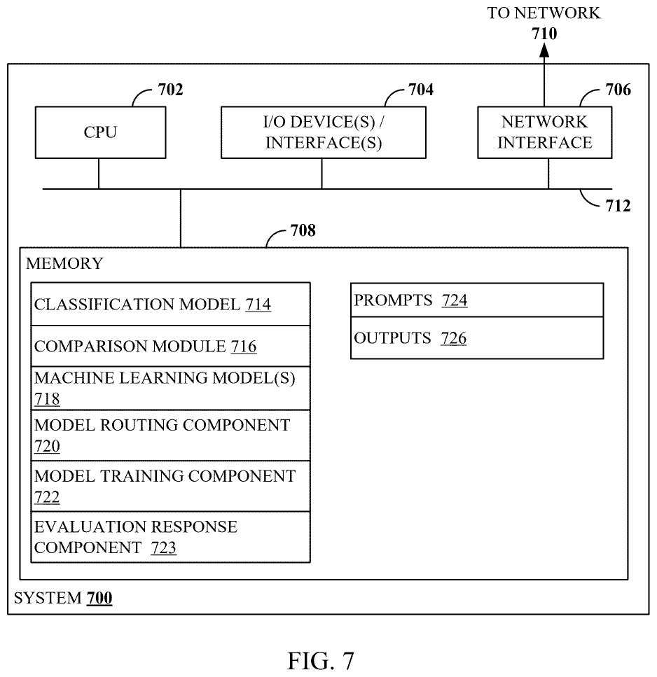

FIG. 7 illustrates an example system 700 with which embodiments of the present disclosure may be implemented. For example, system 700 may be configured to perform operations 500 of FIG. 5 or operations 600 of FIG. 6 and/or to implement one or more components as in FIG. 1, FIG. 2, FIG. 3, or FIG. 4.

System 700 includes a central processing unit (CPU) 702, one or more I/O device interfaces that may allow for the connection of various I/O devices 704 (e.g., keyboards, displays, mouse devices, pen input, etc.) to the system 700, network interface 706, a memory 708, and an interconnect 712. It is contemplated that one or more components of system 700 may be located remotely and accessed via a network 710. It is further contemplated that one or more components of system 700 may comprise physical components or virtualized components.

CPU 702 may retrieve and execute programming instructions stored in the memory 708. Similarly, the CPU 702 may retrieve and store application data residing in the memory 708. The interconnect 712 transmits programming instructions and application data, among the CPU 702, I/O device interface 704, network interface 706, and memory 708. CPU 702 is included to be representative of a single CPU, multiple CPUs, a single CPU having multiple processing cores, and other arrangements.

Additionally, the memory 708 is included to be representative of a random access memory or the like. In some embodiments, memory 708 may comprise a disk drive, solid state drive, or a collection of storage devices distributed across multiple storage systems. Although shown as a single unit, the memory 708 may be a combination of fixed and/or removable storage devices, such as fixed disc drives, removable memory cards or optical storage, network attached storage (NAS), or a storage area-network (SAN).

As shown, memory 708 includes classification model 714, comparison module 716, machine learning model(s) 718, model routing component 720, and model training component 722. Classification model 714 may be representative of classification model 200 of FIG. 2 or FIG. 3. In some embodiments, comparison module 716 may be representative of comparison module 420 of FIG. 4. Machine learning model(s) 718 may be representative of content generation machine learning model 110 of FIG. 1 or FIG. 2, evaluation models 315A-D of FIG. 3, and generative models 215A-D of FIG. 2. Model routing component 720 may be representative of model routing component 210 of FIG. 2 or FIG. 3. Model training component 722 may be representative of model training component 240 of FIG. 2. Evaluation response component 723 may be representative of Evaluation response component 340 of FIG. 3.

Memory 708 further comprises prompts 724, which may correspond to any of the prompts described herein. Memory 708 further comprises outputs 726 which may correspond to any of the outputs described herein.

It is noted that in some embodiments, system 700 may interact with one or more external components, such as via network 710, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of automated content generation, comprising:
providing a prompt as input to a generative model and a classification model;
receiving a given output generated by the generative model based on the prompt;
routing the prompt and the given output to a given evaluation machine learning model based on an output generated by the classification model based on the prompt, wherein the output generated by the classification model indicates a type for the prompt, wherein the given evaluation machine learning model has been optimized for prompts having a particular type;
receiving, based on the prompt and the given output, a particular output from the given evaluation machine learning model; and
performing one or more actions based on the particular output.

2. The method of claim 1, wherein the one or more actions comprise retraining the generative model based on the particular output indicating a deficiency in the given output.

3. The method of claim 1, wherein the one or more actions comprise repeating one or more content generation steps based on the particular output indicating a deficiency in the given output.

4. The method of claim 1, wherein the one or more actions comprise providing the given output to a user via a user interface based on the particular output indicating a lack of deficiencies in the given output.

5. The method of claim 1, wherein optimization for the given evaluation machine learning model is based on a number of parameters of the given evaluation machine learning model.

6. The method of claim 1, wherein routing the prompt and the given output to the given evaluation machine learning model comprises, based on the output generated by the classification model indicating that the prompt has a relatively low level of complexity, routing the prompt and the given output to the given evaluation machine learning model, wherein the given evaluation machine learning model has a number of parameters or a level of quantization that corresponds to the relatively low level of complexity.

7. The method of claim 1, wherein routing the prompt and the given output to the given evaluation machine learning model comprises, based on the output received from the classification model indicating that the prompt has a relatively high level of complexity, routing the prompt and the given output to the given evaluation machine learning model, wherein the given evaluation machine learning model has a number of parameters or a level of quantization that corresponds to the relatively high level of complexity.

8. The method of claim 1, further comprising:
receiving user feedback based on the given output; and
retraining the given evaluation machine learning model based on the user feedback.

9. The method of claim 1, further comprising:
receiving user feedback based on the given output; and
retraining the classification model based on the user feedback.

10. A method of training a content generation machine learning model, comprising:
receiving a training prompt;
providing the training prompt as an input to a classification model, wherein the classification model has been trained to route prompts to machine learning models based on a type that corresponds to the prompts;
routing the training prompt to a particular generative machine learning model based on an output received from the classification model, wherein the particular generative machine learning model has been optimized for prompts having a particular type;
receiving a given output generated by the particular generative machine learning model based on the training prompt; and
training the content generation machine learning model through a supervised learning process comprising:
providing the training prompt as input to the content generation machine learning model;
receiving an output generated by the content generation machine learning model based on the training prompt; and
adjusting parameters of the content generation machine learning model based on comparing the output generated by the content generation machine learning model to the given output.

11. The method of claim 10, wherein the trained content generation machine learning model is used to generate content based on an input prompt.

12. The method of claim 11, further comprising:
receiving user feedback based on the generated content; and
retraining the content generation machine learning model based on the user feedback.

13. The method of claim 11, further comprising:
receiving user feedback based on the generated content; and
retraining the classification model based on the user feedback.

14. The method of claim 10, further comprising:
routing a plurality of training prompts, each training prompt of the plurality of training prompts corresponding to a different use case, to generative machine learning models based on a type corresponding to each training prompt of the plurality of training prompts; and
receiving a set of outputs from the generative machine learning models based on the prompts, each respective output of the set of outputs corresponding to a respective training prompt of the plurality of training prompts, wherein training the content generation machine learning model further comprises, for each given training prompt of the plurality of training prompts, adjusting parameters of the content generation machine learning model based on comparing an output generated by the content generation machine learning model for the given training prompt to a given output of the set of outputs that corresponds to the given training prompt.

15. The method of claim 10, wherein optimization for the particular generative machine learning model is based on a number of parameters of the particular generative machine learning model.

16. The method of claim 10, wherein routing the training prompt to the particular generative machine learning model comprises, based on the output received from the classification model indicating that the training prompt has a relatively low level of complexity, routing the prompt to the particular generative machine learning model, wherein the particular generative machine learning model has a number of parameters that corresponds to the relatively low level of complexity.

17. The method of claim 10, wherein routing the training prompt to the particular generative machine learning model comprises, based on the output received from the classification model indicating that the training prompt has a relatively high level of complexity, routing the prompt to the particular generative machine learning model, wherein the particular generative machine learning model has a number of parameters or a level of quantization that corresponds to the relatively high level of complexity.

18. The method of claim 10, wherein:
embedding representations of the output generated by the content generation machine learning model and the given output are created; and
the adjusting continues until the embedding representation of the output generated by the content generation machine learning model and the embedding representation of the given output have a level of semantic similarity above a threshold.

19. A system for automated content generation, comprising:
one or more processors; and
a memory comprising instructions that, when executed by the one or more processors, cause the system to:
provide a prompt as input to a generative model and a classification model;
receive a given output generated by the generative model based on the prompt;
route the prompt and the given output to a given evaluation machine learning model based on an output generated by the classification model based on the prompt, wherein the output generated by the classification model indicates a type for the prompt, wherein the given evaluation machine learning model has been optimized for prompts having a particular type;
receive, based on the prompt and the given output, a particular output from the given evaluation machine learning model; and
perform one or more actions based on the particular output.

20. The system of claim 19, wherein the one or more actions comprise providing the given output to a user via a user interface based on the particular output indicating a lack of deficiencies in the given output.
